(19) United States
(12) Patent Application Publication
(10) Pub. No.: US 2025/0274481 A1
(43) Pub. Date: Aug. 28, 2025

(54) DEACTIVATION OF DECENTRALIZED DOMAINS

(71) Applicant: Unstoppable Domains, Inc., Las Vegas, NV (US)

(72) Inventors: Lisa Seacat DeLuca, Bozeman, MT (US); Matthew Gould, Atlanta, GA (US); Thomas Frederic Irish, Rockville, MD (US)

(21) Appl. No.: 18/590,062

(22) Filed: Feb. 28, 2024

(51) Int. Cl. H04L 9/40

(52) U.S. Cl. CPC H04L 63/1441; H04L 63/1416

(57) ABSTRACT

According to a present invention embodiment, a system for deactivating decentralized domains comprises one or more memories and at least one processor coupled to the one or more memories. The system monitors for occurrence of a set of conditions associated with a decentralized domain of a decentralized system. The decentralized domain is deactivated in response to the occurrence of the set of conditions. Embodiments of the present invention further include a method and computer program product for deactivating decentralized domains in substantially the same manner described above.

### TECHNICAL FIELD

Present invention embodiments relate to deactivation of a decentralized domain (e.g., a blockchain domain, etc.). For example, an embodiment of the present invention provides a mechanism to support takedown or deactivation of decentralized domains, such as registered domain names on a blockchain. The mechanism may be implemented by a smart contract of the blockchain, application programming interfaces (APIs), distributed or decentralized applications (dApps), blockchain related applications, or any combinations thereof.

### BACKGROUND

### Discussion of the Related Art

A domain takedown is a process that identifies and deactivates domains that may be malicious, such as domains associated with phishing attacks or illegal activity. Visitors to these domains are often subject to scams that fraudulently obtain their assets or money. This has been impacting traditional (or Web2) domains likely as early as their inception. Web2 generally refers to a version of the web (or Internet) that utilizes a centralized Domain Name System (DNS) to translate domain names into corresponding Internet Protocol (IP) addresses in order to access a web site.

A decentralized (or blockchain) domain name may be stored on a blockchain. The blockchain domain name is associated with software or smart contracts on the blockchain that may perform various functions (e.g., indicate locations of content for the domain (e.g., or a web site, etc.) hosted on the blockchain, etc.). Since a private key of a user wallet enables the user to have sole control of the blockchain domain, deactivating a malicious blockchain domain by another party becomes difficult.

### SUMMARY

According to one embodiment of the present invention, a system for deactivating decentralized domains comprises one or more memories and at least one processor coupled to the one or more memories. The system monitors for occurrence of a set of conditions associated with a decentralized domain of a decentralized system. The decentralized domain is deactivated in response to the occurrence of the set of conditions. Embodiments of the present invention further include a method and computer program product (e.g., including one or more computer readable media with instructions executable by one or more processors) for deactivating decentralized domains in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of identifying and deactivating a decentralized domain according to an embodiment of the present invention.

FIG. 4 is a flowchart of a method of monitoring and deactivating a decentralized domain according to an embodiment of the present invention.

FIG. 5 is a flowchart of a method of deactivating a decentralized domain according to an embodiment of the present invention.

FIG. 6 is a flowchart of a method of accessing a decentralized domain according to an embodiment of the present invention.

### DETAILED DESCRIPTION

A domain of a network generally refers to a portion of network resources and may include any item associated with those network resources (e.g., a domain name, a web site, web site content, a service, control, etc.). A domain takedown is a process that identifies and deactivates (or renders inaccessible) domains that may be malicious, such as domains associated with phishing attacks or illegal activity. Visitors to these domains are often subject to scams that fraudulently obtain their assets or money. This has been impacting traditional (or Web2) domains likely as early as their inception. Web2 generally refers to a version of the web (or Internet) that utilizes a centralized Domain Name System (DNS) to translate domain names into corresponding Internet Protocol (IP) addresses in order to access a web site.

A decentralized domain may include any domain (e.g., a domain name, network resources, web site, service, content, control, etc.) supported or residing on a decentralized system or network. Since there typically is no centralized authority, deactivating a malicious decentralized domain becomes difficult. For example, Web3 generally refers to a decentralized version of the web (or Internet) based on blockchains and peer-to-peer networks. A decentralized domain may include a blockchain domain (e.g., a Web3 domain) that is stored on a blockchain. A blockchain domain name may be associated with any digital asset (e.g., non-fungible token (NFT), a wallet address (or account), an object that points to a set of records containing domain information, set of records containing domain information, etc.). The blockchain domain name is preferably associated with a user wallet address (or account) that is used to verify the user based on the user signing a message within the user wallet (e.g., application) using cryptographic keys. The blockchain domain is associated with software or smart contracts on the blockchain that may perform various functions (e.g., indicate locations of content for the domain (e.g., or a web site, etc.) hosted on the blockchain, etc.). Since a private key of a user wallet (e.g., application) enables the user to have sole control of the blockchain domain, deactivating a malicious blockchain domain by another party becomes difficult.

Accordingly, embodiments of the present invention provide a mechanism to support takedown or deactivation of decentralized domains, such as registered domains on a blockchain (e.g., Web3 domains, etc.). A decentralized domain may include any domain (e.g., a domain name, network resources, web site, service, content, control, etc.) supported or residing on a decentralized system or network. The domain takedown or deactivation of present invention embodiments includes removing control (or transferring ownership) of a decentralized domain from a current user/owner and/or disabling (or preventing access to) any aspect of a decentralized domain (e.g., domain name, network resources, web site, service, content, control, etc.).

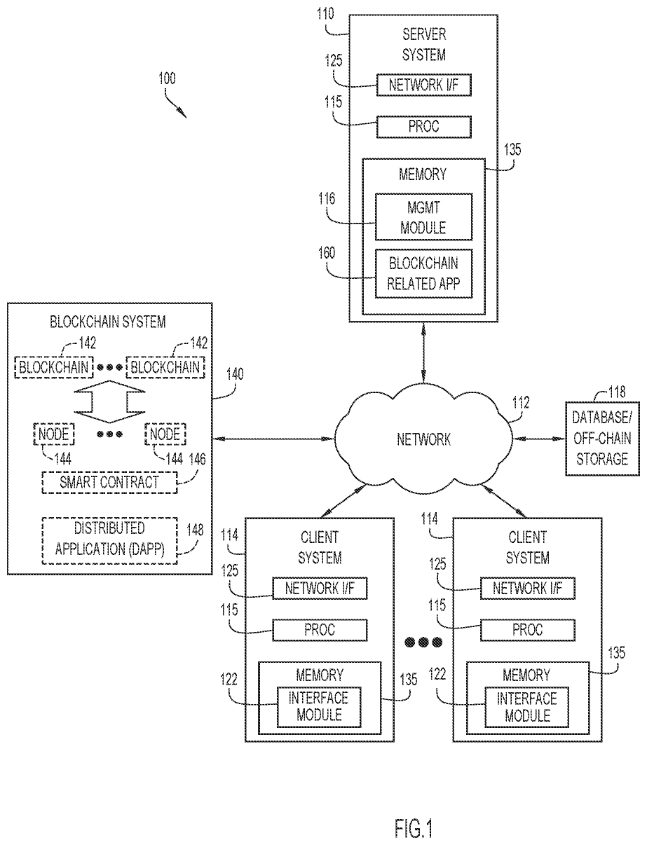

An example environment 100 for use with present invention embodiments is illustrated in FIG. 1. Specifically, environment 100 includes one or more server systems 110, one or more client or end-user systems 114, and one or more blockchain systems 140 each implementing and maintaining at least one corresponding blockchain 142. Server systems 110, client systems 114, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform domain management (e.g., register and/or manage decentralized domain names, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing and accessing domains. The interface module may include any conventional or other browser to access server systems 110 and blockchain systems 140.

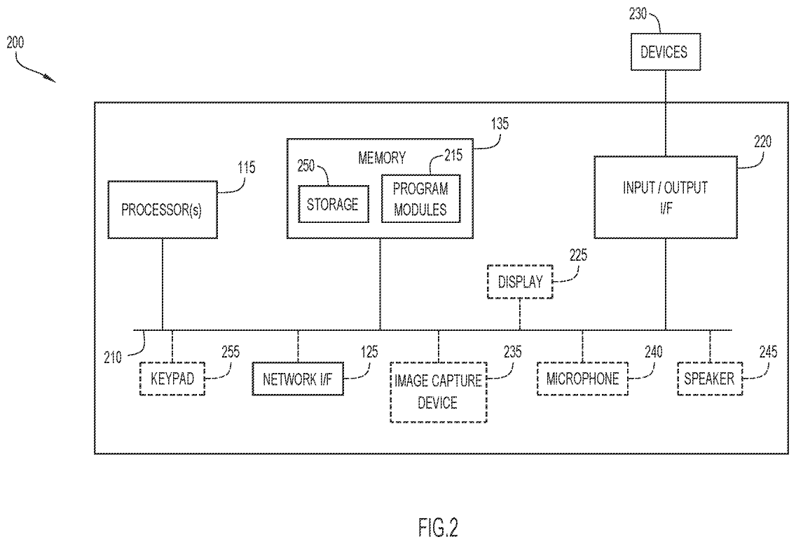

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more smart contracts 146 and one or more distributed or decentralized applications (dApps) 148 to perform various operations (e.g., financial or other transactions or operations related to a blockchain, deactivation of decentralized domains, access of decentralized domains, etc.). The blockchain domains may be associated with the same and/or various different blockchains.

Interface module 122 of client systems 114 may further provide a graphical user (e.g., GUI, etc.) or other interface (e.g., command line prompts, menu screens, etc.) that enables users to access distributed applications (dApps) 148 on blockchain systems 140 for performing various operations (e.g., financial or other transactions or operations related to a blockchain, deactivation and/or access of decentralized domains, etc.). The interface module may include any conventional or other browser to access the distributed applications (dApps) of blockchain systems 140. The interface module may natively, or include extensions to, access the distributed applications (dApps) and/or other components of blockchain system 140. The interface module may provide a user interface to serve as a front end for a distributed application (dApp) 148, where back end processing for the distributed application (dApp) is performed on a blockchain system 140. Client systems 114 may further provide reports or notifications pertaining to requests from users (e.g., results of an access request, verification results, etc.).

Server systems 110 further include one or more blockchain related applications 160 for performing various operations (e.g., transactions or operations related to a blockchain, access domain information, deactivate decentralized domains, etc.). Management module 116 and blockchain related applications 160 may be on the same or different server systems 110. The blockchain related application may process requests from any entities (e.g., user, application, service, computing or other device, etc.).

A database or off-chain storage system 118 may store various information for a domain and/or domain deactivation (e.g., domain information, mappings of blockchain domains to blockchains, deactivation listings or indications, web site content, etc.). The database system may be implemented by any conventional or other database or off-chain storage unit (e.g., Interplanetary File System (IPFS), etc.), may be local to or remote from server systems 110, client systems 114, and/or blockchain systems 140, and may communicate via any appropriate communication medium (e.g., local area network (LAN), wide area network (WAN), Internet, hardwire, wireless link, Intranet, etc.).

Server systems 110 and client systems 114 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, smart contracts 146, distributed applications (dApps) 148, and blockchain related applications 160 may include one or more modules or units to perform the various functions of present invention embodiments described below. The various modules (e.g., management module 116, interface module 122, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., smart contracts 146, distributed applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, blockchain software (e.g., smart contracts 146, distributed applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A decentralized domain may include any domain (e.g., a domain name, network resources, web site, service, content, control, etc.) supported or residing on a decentralized system or network. For example, a decentralized domain may include a blockchain domain that is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

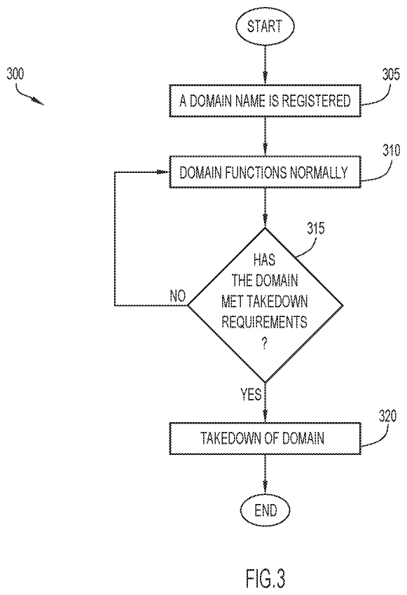

A method 300 of identifying and deactivating a decentralized domain (e.g., via management module 116, smart contract 146, blockchain related application 160, server system 110, client system 114, and/or blockchain system 140) according to an embodiment of the present invention is illustrated in FIG. 3. By way of example, method 300 is described with respect to a decentralized domain including a blockchain domain. However, any decentralized domain may be identified and deactivated in substantially the same manner described below.

Initially, a user may register a decentralized or blockchain domain (or domain name) (e.g., via management module 116) at operation 305. The blockchain domain name may include any quantity of terms, words, tokens, or arrangements of any quantity of any types of elements (e.g., alphanumeric or other characters, symbols, numbers, etc.). For example, the blockchain domain name may include a name portion and an optional extension (preferably indicating a corresponding blockchain) (e.g., “name.e1”, etc.). The name portion and extension may each include any quantity of terms, words, tokens, or arrangements of any quantity of any types of elements (e.g., alphanumeric or other characters, symbols, numbers, etc.).

Preferences or conditions triggering deactivation of the decentralized domain may be managed by a domain smart contract 146 associated with the decentralized domain. The decentralized domain operates in an intended manner at operation 310 (e.g., performing transactions, providing content, etc.), while the domain smart contract monitors for occurrence of the preferences or conditions. When the preferences or conditions are satisfied as determined at operation 315, the decentralized domain is deactivated (e.g., via domain smart contract 146, decentralized application (dApp) 148, and/or blockchain related application 160, etc.) at operation 320. The takedown or deactivation includes removing control (or transferring ownership) of the decentralized domain from a current user/owner and/or disabling (or preventing access to) any aspect of the decentralized domain (e.g., domain name, network resources, web site, service, content, control, etc.). The deactivation may be permanent or reversible (e.g., effective deactivation) as described below.

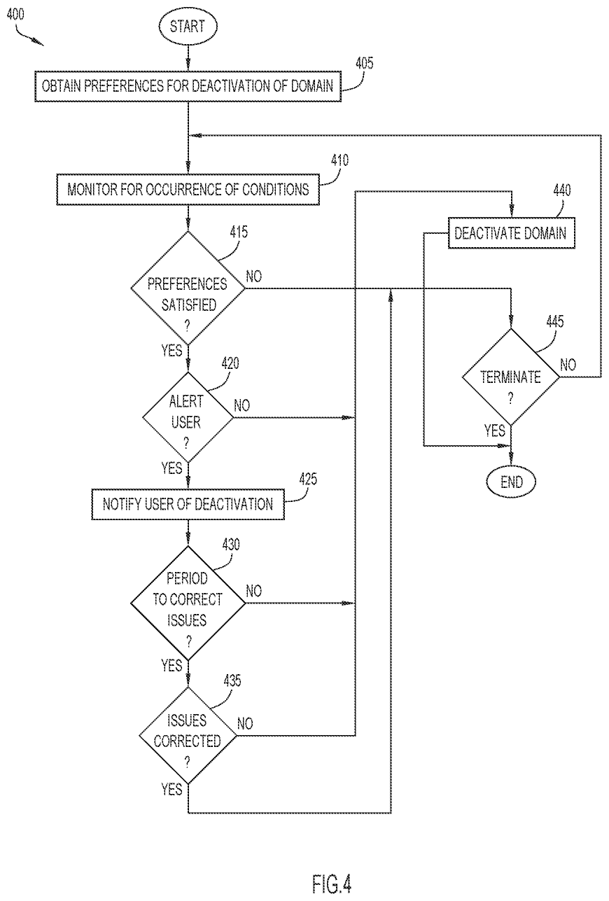

A method 400 of monitoring and deactivating a decentralized domain (e.g., via smart contract 146, decentralized application (dApp) 148, blockchain related application 160, server system 110, client system 114, and/or blockchain system 140) according to an embodiment of the present invention is illustrated in FIG. 4. By way of example, method 400 is described with respect to a decentralized domain including a blockchain domain. However, any decentralized domain may be monitored and deactivated in substantially the same manner described below.

Initially, a user registers a decentralized or blockchain domain (or domain name) as described above (e.g., via management module 116, etc.). The blockchain domain name may include any quantity of terms, words, tokens, or arrangements of any quantity of any types of elements (e.g., alphanumeric or other characters, symbols, numbers, etc.). For example, the blockchain domain name may include a name portion and an optional extension (preferably indicating a corresponding blockchain) (e.g., “name.e1”, etc.). The name portion and extension may each include any quantity of terms, words, tokens, or arrangements of any quantity of any types of elements (e.g., alphanumeric or other characters, symbols, numbers, etc.).

The preferences or conditions for deactivation of the decentralized domain are obtained and managed by a domain smart contract 146 associated with the decentralized domain at operation 405. The preferences or conditions for deactivation of the decentralized domain may be obtained in any manner. For example, the preferences or conditions may be provided by a user on a user interface of interface module 122 of a client system 114, and transferred to domain smart contract 146 via an API utilized by a decentralized application (dApp) 148 or a blockchain related application 160. Further, the preferences or conditions may be preconfigured or updated into the domain smart contract.

The preferences or conditions may include any desired preferences or conditions for deactivating a decentralized domain. For example, the preferences or conditions may include a number of signed messages (from user wallets) requesting or indicating a takedown is warranted. In this case, a takedown may be triggered when a sufficient number of users sign messages from their wallets indicating problems or issues with the decentralized domain. The signed messages may be sent to the decentralized domain for monitoring by the domain smart contact. Further, the preferences or conditions may include a time period (e.g., days, weeks, months, years, etc.) in which the messages need to be signed by the wallets to indicate the takedown. For example, a time of period of a few years between signed messages is likely insufficient to indicate a valid issue. Moreover, the preferences or conditions may consider or accept signed messages from wallets (or users) having accounts with safety or reliability scores satisfying a threshold indicating a safe or reliable user or wallet account. The safety score may be based on reliability or safety scores of parties (users or wallet accounts) of transactions, quantity of invalid transactions, etc. In addition, the preferences or conditions may consider or accept the signed messages based on the age of the wallet account. By way of example, users may create new wallet accounts for malicious purposes, where an older wallet account may indicate greater validity.

Moreover, the preferences and conditions may be based on a reviewing authority that performs a review of the decentralized domain and provides a signed message on behalf of a domain takedown organization. In addition, the preferences or conditions may be based on a safety or reliability score of the decentralized domain. In this case, the safety or reliability score may be compared to a threshold indicating a safe or reliable domain. The safety score may be based on reliability or safety scores of parties (users or wallet accounts) accessing the decentralized domain, content, quantity of complaints, ratings, and/or invalid transactions, etc. Once the domain becomes unsafe, deactivation may be initiated (e.g., as opposed to requiring others to mark the decentralized domain for deactivation). Satisfaction of a set of any quantity or combination of the preferences or conditions may trigger deactivation of the decentralized domain.

Domain smart contract 146 monitors for occurrence of the set of preferences or conditions for the decentralized domain at operation 410. When the set of preferences or conditions for deactivation are satisfied as determined at operation 415, domain smart contract 146 may deactivate or take down the decentralized domain. In particular, the user may be notified or alerted of the deactivation or takedown. When the user is to be alerted as determined at operation 420, the user is sent a notification indicating deactivation of the decentralized domain and reasons for the deactivation (e.g., the preferences or conditions triggering the deactivation, etc.). This may be accomplished by the domain smart contract providing an indication to a decentralized application (dApp) 148 that sends a notification to the user (e.g., directly or via a blockchain related application 160). For example, the notification may be sent via any type of communication (e.g., email, text or other message, message on client system 114, etc.), and may be based on user information associated with the decentralized domain (e.g., retrieved from on-chain or off-chain storage).

The user may be provided a time period (e.g., days, weeks, months, etc.) to correct issues in order to avoid deactivation of the decentralized domain. When the user is provided time for correction as determined at operation 430, domain smart contract 146 examines the decentralized domain for correction of the issues at expiration of the time period. When no time is provided for correction as determined at operation 430, or the issues have not been corrected after expiration of the time period as determined at operation 435, domain smart contract 146 (and/or decentralized application (dApp) 148 and/or blockchain related application 160) deactivate the decentralized domain at operation 440 and the process terminates. The takedown or deactivation of the decentralized domain includes removing control (or transferring ownership) of the decentralized domain from a current user/owner and/or disabling (or preventing access to) any aspect of a decentralized domain (e.g., domain name, network resources, web site, service, content, control, etc.).

When the set of preferences or conditions for deactivation are not satisfied as determined at operation 415, or issues have been corrected as determined at operation 435, the decentralized domain continues to remain active and the domain smart contract monitors for occurrence of the set of preferences or conditions for deactivation from operation 410 as described above. The process continues until termination (e.g., power down, disable the monitoring, etc.) as determined at operation 445.

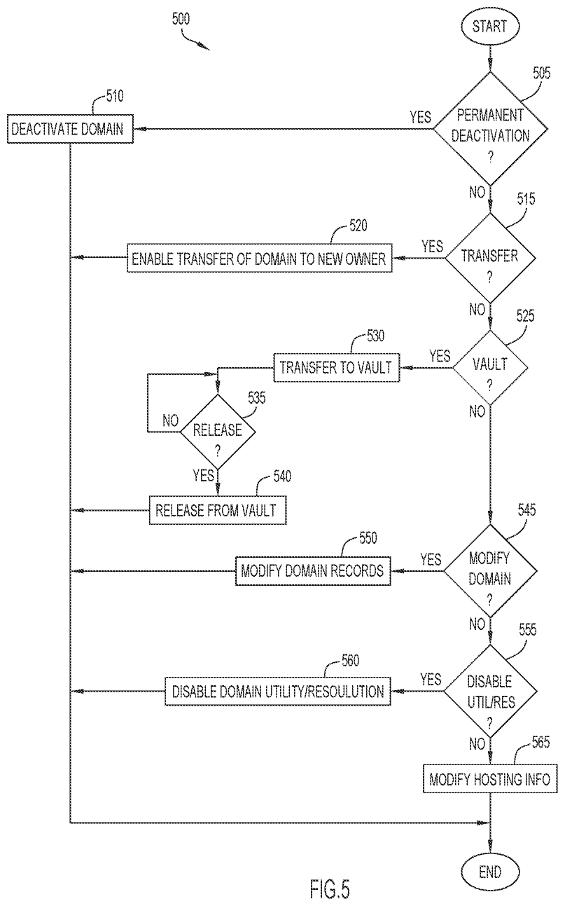

A decentralized domain may be deactivated in various manners. The takedown or deactivation of the decentralized domain includes removing control (or transferring ownership) of the decentralized domain from a current user/owner and/or disabling (or preventing access to) any aspect of the decentralized domain (e.g., domain name, network resources, web site, service, content, control, etc.). A method 500 of deactivating a decentralized domain (e.g., via smart contract 146, decentralized application (dApp) 148, blockchain related application 160, server system 110, client system 114, and/or blockchain system 140) according to an embodiment of the present invention is illustrated in FIG. 5. This may correspond to operation 440 of FIG. 4. By way of example, method 500 is described with respect to a decentralized domain including a blockchain domain. However, any decentralized domain may be deactivated in substantially the same manner described below.

Initially, a decentralized domain is monitored and identified for deactivation by a domain smart contract 146 associated with the decentralized domain in response to satisfaction of a set of preferences or conditions for deactivation in substantially the same manner described above. The domain smart contract is preferably configured, or may be configurable (e.g., by a user or other entity via an on-chain or other record or parameter, etc.), to deactivate the decentralized domain in a particular manner.

When deactivation of the decentralized domain is to be permanent as determined at operation 505, domain smart contract 146 permanently deactivates (or burns) the decentralized domain at operation 510. This may be accomplished by the domain smart contract posting a transaction on a corresponding blockchain of the decentralized domain that transfers the decentralized domain to a special wallet account or address. The private key of the wallet may be unknown or kept secret to prevent access, changes, and/or transfer of the decentralized domain, thereby rendering the deactivation permanent (or irreversible). Since the posted transaction on the blockchain is public, the posted transaction provides an indication of the decentralized domain in the special wallet account and prevents future registrations for the decentralized domain.

The decentralized domain may be transferred to a new owner in order to deactivate the decentralized domain with respect to a current user. When the decentralized domain is to be transferred as determined at operation 515, the domain smart contract posts a transaction to the corresponding blockchain temporarily storing the decentralized domain in a holding wallet account or address to remove control from the current user and enable the decentralized domain to be offered for sale or transfer (e.g., in an online marketplace, via blockchain related application 160, etc.). Once a new user is identified, the domain smart contract transfers the decentralized domain to the new user at operation 520. This may be accomplished by the domain smart contract posting a transaction to a corresponding blockchain transferring ownership of the decentralized domain to the new user (e.g., transferring the decentralized domain to a wallet account or address of the new user). The domain smart contract may be informed of the new user via an application programming interface (API) utilized by the online marketplace or blockchain related application 160.

The decentralized domain may be transferred to a monitored vault (or wallet account or address) until a set of release requirements are satisfied. When the decentralized domain is to be transferred to the vault as determined at operation 525, the domain smart contract transfers the decentralized domain to the vault at operation 530. This may be accomplished by the domain smart contract posting a transaction to a corresponding blockchain transferring the decentralized domain to the vault (or corresponding wallet account or address). Domain smart contract 146 may monitor the decentralized domain for satisfaction of the release requirements (e.g., a decision from appealing the deactivation, a time period, etc.). When the release requirements are satisfied as determined at operation 535, the domain smart contract releases the decentralized domain from the vault at operation 540 and transfers the decentralized domain to the original or another user. This may be accomplished by the domain smart contract posting a transaction to a corresponding blockchain transferring the decentralized domain to the wallet account or address of the original or other user.

The decentralized domain may be effectively (or indirectly) deactivated by preventing access or functionality of the decentralized domain. For example, a record on the corresponding blockchain for the decentralized domain may be created or modified to indicate the decentralized domain has been marked for takedown or deactivation. This modifies the decentralized domain. When the decentralized domain is to be modified for deactivation as determined at operation 545, domain smart contract 146 creates or modifies a record on the corresponding blockchain for the decentralized domain to indicate the decentralized domain has been marked for takedown or deactivation at operation 550.

In addition, other records associated with the decentralized domain (e.g., on-chain, off-chain, etc.) may be disabled (e.g., unset, made unavailable, etc.) to indicate deactivation or takedown of the decentralized domain. Further, metadata of the decentralized domain (e.g., on-chain or off-chain) may be modified. The metadata may specify storage locations (e.g., on-chain or off-chain) of various items (e.g., images, etc.). The metadata may be modified to specify a location providing an indication of deactivation of the decentralized domain (e.g., adding a property, overriding a location for an image or other item indicated in the metadata, etc.). The domain smart contact may modify the on-chain records or metadata to deactivate the decentralized domain. In the case of off-chain records or metadata (e.g., in off-chain storage system 118, etc.), the domain smart contract may provide an indication to a decentralized application 148 (dApp) to modify the off-chain records or metadata (e.g., directly or via a blockchain related application 160).

When the decentralized domain is accessed, the corresponding records or metadata indications are checked. When the records or metadata indications indicate deactivation of the decentralized domain (e.g., notification, unavailable, unset, etc.), access to the decentralized domain is prevented, thereby effectively (or indirectly) deactivating the decentralized domain.

Further, the deactivation may be indicated without modifying (records of) the decentralized domain. In this case, the utility or resolution capability of the decentralized domain may be disabled. When the utility or resolution capability is to be disabled as determined at operation 555, the utility or resolution capability of the decentralized domain is disabled at operation 560. For example, a deactivation smart contract 146 (e.g., separate from the domain smart contract associated with the decentralized domain, etc.) may include or have access to a list of decentralized domains that are to be deactivated. The list may include any identifying information for a decentralized domain (e.g., wallet address or account, owner information, blockchain information, record locations, etc.). When a decentralized domain is to be deactivated, the domain smart contract associated with the decentralized domain informs or directs the separate deactivation smart contract to add the decentralized domain to the list at operation 560. In this case, when the decentralized domain is accessed, the deactivation smart contract is contacted to access and/or provide the list. When the domain smart contract (and/or the deactivation smart contract) determines that the decentralized domain appears on the list, access to the decentralized domain is prevented (e.g., no record or other domain information is returned), thereby effectively deactivating the decentralized domain. This approach avoids updating the decentralized domain (e.g., non-fungible token (NFT), etc.) itself, but rather prevents utilization of the decentralized domain.

Moreover, a standalone tracking smart contract 146 (e.g., providing a service, etc.) may be employed for tracking deactivations or takedowns (e.g., maintain a listing of deactivated decentralized domains, etc.). When a decentralized domain is to be deactivated as determined at operation 555, the domain smart contract associated with the decentralized domain informs or directs the tracking smart contract to add the decentralized domain to the list at operation 560. In this case, when the decentralized domain is accessed, the tracking smart contract is invoked to check the list. Record information for the decentralized domain may include cryptocurrency address resolutions, Interplanetary File System (IPFS)/website resolutions, and any other free-form data to resolve these items for accessing the decentralized domain (e.g., resolve these items to the domain location, content locations, etc.). When the decentralized domain appears on the list, no record or other domain information is returned, thereby effectively disabling resolution functionality of (or access to) the decentralized domain.

In addition, hosting information may be modified to disable the decentralized domain. For example, hosting information may be stored in a record off-chain (e.g., in off-chain storage system 118, etc.) and indicate a location for a web site associated with the decentralized domain (e.g., blockchain or other address for the web site and/or content, etc.). When hosting information is to be modified as determined at operation 555 (e.g., other deactivations are not employed for the decentralized domain), the hosting information is modified to deactivate the decentralized domain at operation 565. For example, domain smart contract 146 may inform or direct a decentralized application (dApp) 148 to replace, or modify, an off-chain record (e.g., Interplanetary File System (IPFS) record, etc.) including information that points to a web site or other content associated with the decentralized domain. The decentralized application (dApp) may access the off-chain storage (e.g., either directly or via a blockchain related application 160) to modify the information in the off-chain record to include a warning indicating the decentralized domain is being taken down, an indicator or address to redirect an access request to a landing page, or a blank value. The landing page may provide a notification (e.g., indicating a reason that a decentralized domain was deactivated, etc.) and include a link to an information page (e.g., describing deactivation of decentralized domains, etc.).

Partial takedowns may be performed for different networks. For example, a domain name used for Web2 and Web3 may violate rules for Web2, but may satisfy rules for Web3. In this case, the domain (or domain name) may be deactivated for Web2 in a conventional manner, while retaining the domain name for Web3. Further, the domain name may violate rules for Web3, but may satisfy rules for Web2. In this case, the domain (or domain name) may be deactivated in substantially the same manner described above for Web3, while retaining the domain name for Web2.

In addition, a deactivation of a decentralized domain may be appealed to a reviewing authority (if such authority exists). The deactivations described above based upon modifying record information, deactivation lists, and/or metadata for decentralized domains may be reversible in the event the deactivation is determined to be inappropriate. In this case, the data for the decentralized domain may be retained, and may be used to restore or activate the decentralized domain.

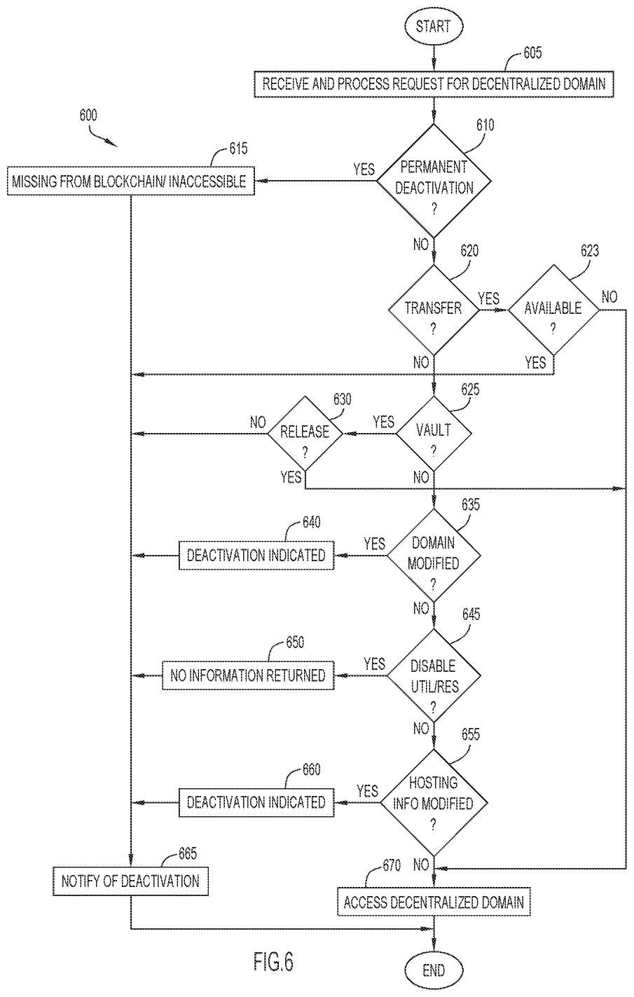

A method 600 of accessing a decentralized domain (e.g., via interface module 122, smart contract 146, decentralized application (dApp) 148, blockchain related application 160, server system 110, client system 114, and/or blockchain system 140) according to an embodiment of the present invention is illustrated in FIG. 6. By way of example, method 600 is described with respect to a decentralized domain including a blockchain domain. However, any decentralized domain may be accessed in substantially the same manner described below.

Initially, a request for accessing a decentralized domain is received and processed by interface module 122 of a client system 114 (e.g., from a user, application, or other entity) at operation 605. By way of example, the decentralized domain includes a blockchain domain (or blockchain domain name). For example, the blockchain domain name may include a name portion and an optional extension (preferably indicating a corresponding blockchain) (e.g., “name.e1”, etc.). The name portion and extension may each include any quantity of terms, words, tokens, or arrangements of any quantity of any types of elements (e.g., alphanumeric or other characters, symbols, numbers, etc.). However, the decentralized domain may include any domain supported or residing on a decentralized system or network, and may be deactivated and accessed in substantially the same manner described herein.

Interface module 122 may natively, or include extensions to, access distributed applications (dApps) 148 and/or other components of blockchain system 140 to process the request for the blockchain domain. The blockchain domain name is associated with a domain smart contract 146 on a corresponding blockchain system 140 that may perform various functions (e.g., provide a registry for corresponding wallet addresses, indicate locations of content for the domain (e.g., or a website, etc.) hosted on the blockchain, deactivation of the blockchain domain, etc.). In order to access the blockchain domain, a corresponding blockchain 142 is accessed to find a record corresponding to the blockchain domain name (e.g., containing blockchain domain address and other domain information, etc.). The blockchain may be accessed via decentralized application (dApp) 148 and/or blockchain related application 160 (e.g., depending on support for interface module 122 for decentralized domains, etc.) to access and analyze the record.

However, the blockchain domain may have been deactivated or taken down in various manners as described above. For example, the blockchain domain may have been permanently deactivated as described above and determined at operation 610. In this case, the record for the blockchain domain retrieved from the blockchain and analyzed by decentralized application (dApp) 148 and/or blockchain related application 160 indicates that the blockchain domain resides in a special (inaccessible) wallet account (e.g., based on the blockchain domain address or wallet account in the record, etc.) at operation 615 and, therefore, is deactivated (or inaccessible). When permanent deactivation of the blockchain domain has occurred, decentralized application (dApp) 148 and/or blockchain related application 160 provide notification of the deactivation to interface module 122 for presentation (e.g., to a user, etc.) at operation 665.

Further, the blockchain domain may have been deactivated based on a transfer as described above and determined at operation 620. In this case, the record for the blockchain domain retrieved from the blockchain and analyzed by decentralized application (dApp) 148 and/or blockchain related application 160 may indicate new ownership or availability (e.g., based on wallet information of a new owner, a holding wallet account or address, etc.). When the blockchain domain has been transferred to a new owner (e.g., based on the wallet information in the record, etc.) as determined at operation 623, the domain smart contract for the blockchain domain is initiated (e.g., by decentralized application (dApp) 148 and/or blockchain related application 160) to access and provide functionality for the blockchain domain (e.g., web site, content, etc.). Decentralized application (dApp) 148 may be utilized by the domain smart contract for retrieving off-chain information for the blockchain domain (e.g., directly or via a blockchain related application 160). Decentralized application (dApp) 148 and/or blockchain related application 160 provide the content of the blockchain domain (e.g., derived from on-chain and off-chain storage) to interface module 122 for presentation (e.g., to a user, etc.) at operation 670. Interface module 122 may further provide a notification (e.g., to a user, etc.) that the blockchain domain has been transferred to a new owner.

When the blockchain domain is still available (e.g., has been deactivated and not yet transferred to a new owner based on information for the holding wallet account or address in the record, etc.) as determined at operation 623, decentralized application (dApp) 148 and/or blockchain related application 160 provide notification of the deactivation and availability for transfer to interface module 122 for presentation (e.g., to a user, etc.) at operation 665.

The blockchain domain may have been deactivated by transferring the blockchain domain to a monitored vault (or wallet account or address) until a set of release requirements are satisfied as described above and determined at operation 625. In this case, the record retrieved from the blockchain and analyzed by decentralized application (dApp) 148 and/or blockchain related application 160 may indicate that the blockchain domain remains in the vault (e.g., based on a vault wallet address or account in the record), or has been released (e.g., based on a user wallet address or account in the record). When the blockchain domain has been released (e.g., based on the wallet information in the record, etc.) as determined at operation 630, the domain smart contract for the blockchain domain is initiated (e.g., by decentralized application (dApp) 148 and/or blockchain related application 160) to access and provide functionality for the blockchain domain (e.g., web site, content, etc.). Decentralized application (dApp) 148 may be utilized by the domain smart contract for retrieving off-chain information for the blockchain domain (e.g., directly or via a blockchain related application 160). Decentralized application (dApp) 148 and/or blockchain related application 160 provide the content of the blockchain domain (e.g., derived from on-chain and off-chain storage) to interface module 122 for presentation (e.g., to a user, etc.) at operation 670.

When the blockchain domain remains in the vault (e.g., based on the vault wallet information in the record) as determined at operation 630, decentralized application (dApp) 148 and/or blockchain related application 160 provide notification of the deactivation to interface module 122 for presentation (e.g., to a user, etc.) at operation 665.

The blockchain domain may have been deactivated by creating or modifying a record on the corresponding blockchain for the blockchain domain as described above and determined at operation 635. The record may indicate the blockchain domain has been marked for takedown or deactivation (e.g., effectively modifying the blockchain domain). In addition, other records associated with the blockchain domain may have been disabled (e.g., unset, made unavailable, etc.) to indicate deactivation or takedown of the blockchain domain. Further, metadata of the decentralized domain (e.g., on-chain or off-chain) may have been modified to specify a location providing an indication of deactivation of the decentralized domain (e.g., adding a property, overriding an image indicated in the metadata, etc.). The domain smart contract for the blockchain domain is initiated (e.g., by decentralized application (dApp) 148 and/or blockchain related application 160) to access and provide functionality for the blockchain domain (e.g., web site, content, etc.). The domain smart contract may retrieve the record (and the other records or metadata indications) on the blockchain for the blockchain domain, and determine from the records or metadata indications (e.g., deactivation notification, unset, unavailable, etc.) that the blockchain domain had been deactivated at operation 640. When the records or indications indicate deactivation of the decentralized domain (e.g., deactivation notification, unavailable, unset, etc.), domain smart contract 146 (e.g., via decentralized application (dApp) 148 and, optionally, blockchain related application 160) provides notification of the deactivation to interface module 122 for presentation (e.g., to a user, etc.) at operation 665. Decentralized application (dApp) 148 may be utilized by the domain smart contract for retrieving any off-chain records or metadata indications for the blockchain domain (e.g., directly or via a blockchain related application 160) and determine deactivation of the blockchain domain based on the records or metadata indications (e.g., unavailable, unset, etc.). Decentralized application (dApp) 148 and/or blockchain related application 160 provide notification of the deactivation to interface module 122 for presentation (e.g., to a user, etc.) at operation 665.

The blockchain domain may have been deactivated by disabling the utility or resolution capability of the blockchain domain as described above and determined at operation 645. In this case, the domain smart contract for the blockchain domain is initiated (e.g., by decentralized application (dApp) 148 and/or blockchain related application 160) to access and provide functionality for the blockchain domain (e.g., web site, content, etc.).

The separate deactivation smart contract is invoked by the domain smart contract to access and/or provide a list of blockchain domains that are to be deactivated as described above. The list may include any identifying information for a blockchain domain (e.g., wallet address or account, owner information, blockchain information, record locations, etc.). When the blockchain domain appears on the list as determined by the domain smart contract or deactivation smart contract, the domain smart contract prevents any record or other domain information from being returned at operation 650, thereby indicating deactivation of the blockchain domain (and preventing utilization).

Alternatively, the domain smart contract may invoke the tracking smart contract that tracks deactivations or takedowns (e.g., maintain a listing of deactivated decentralized domains, etc.) as described above. Record information for the blockchain domain may include cryptocurrency address resolutions, Interplanetary File System (IPFS)/website resolutions, and any other free-form data to resolve these items for accessing the blockchain domain (e.g., resolve these items to the domain location, content locations, etc.). When the blockchain domain appears on the list as determined by the tracking smart contract, the domain smart contract prevents any record or other domain information from being returned at operation 650, thereby indicating deactivation of the blockchain domain (and effectively disabling resolution functionality).

When no records or information are returned at operation 650 indicating deactivation of the blockchain domain, the domain smart contract (e.g., via decentralized application (dApp) 148 and/or blockchain related application 160) provides notification of the deactivation to interface module 122 for presentation (e.g., to a user, etc.) at operation 665.

The blockchain domain may have been deactivated by modifying hosting information to disable the blockchain domain as described above and determined at operation 655. In this case, the domain smart contract for the blockchain domain is initiated (e.g., by decentralized application (dApp) 148 and/or blockchain related application 160) to access and provide functionality for the blockchain domain (e.g., web site, content, etc.). Decentralized application (dApp) 148 may be utilized by the domain smart contract for retrieving and analyzing an off-chain record (e.g., Interplanetary File System (IPFS) record, etc.) associated with the blockchain domain and including modified hosting information (e.g., directly or via a blockchain related application 160). The hosting information may include a warning indicating the decentralized domain is being taken down, a location for redirecting to a landing page, or a blank value, thereby indicating deactivation of the blockchain domain at operation 660. The domain smart contract (e.g., via decentralized application (dApp) 148 and/or blockchain related application 160) provides notification of the deactivation to interface module 122 for presentation (e.g., to a user, etc.) at operation 665. The notification may include the landing page indicating a reason that a decentralized domain was deactivated and/or a link to an information page describing deactivation of decentralized domains.

When the blockchain domain remains active (e.g., has not been deactivated, etc.) as determined at operation 655, the domain smart contract for the blockchain domain is initiated (e.g., by decentralized application (dApp) 148 and/or blockchain related application 160) to access and provide functionality for the blockchain domain (e.g., web site, content, etc.). Decentralized application (dApp) 148 may be utilized by the domain smart contract for retrieving off-chain information for the blockchain domain (e.g., directly or via a blockchain related application 160). Decentralized application (dApp) 148 and/or blockchain related application 160 provide the content of the blockchain domain (e.g., derived from on-chain and off-chain storage) to interface module 122 for presentation (e.g., to a user, etc.) at operation 670.

Present invention embodiments may provide various technical and other advantages. For example, present invention embodiments provide enhanced security and access control against malicious decentralized domains. By way of example, the decentralized domains are monitored and automatically deactivated upon satisfaction of conditions indicating a malicious domain. Further, decentralized domains are under the sole control of the owner, thereby being difficult to take down or deactivate by another party. Present invention embodiments provide control to enable other parties to deactivate the decentralized domains, either permanently or reversibly (e.g., the decentralized domain may be activated after deactivation). Access to a deactivated decentralized domain is prevented prior to retrieving domain content, thereby conserving computing resources.

It will be appreciated that the embodiments described above and illustrated in the drawings represent only a few of the many ways of implementing embodiments for deactivation of decentralized domains. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, smart contracts 146, distributed applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, smart contracts 146, distributed applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, smart contracts 146, distributed applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., domain information, metadata, mappings of blockchain domains to blockchains, deactivation listings, etc.). The database system may be implemented by any number of conventional or other databases, data stores or storage structures to store information. The database system may be included within or coupled to the server, client, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., results of an access request, domain or web site content, domain information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., deactivated domains, domain information, etc.).

The present invention embodiments are not limited to the specific tasks or algorithms described above, but may be utilized for deactivating any decentralized or other domains based on any preferences or conditions.

A decentralized domain may include any domain (e.g., a domain name, network resources, web site, service, content, control, etc.) supported or residing on any decentralized system or network (e.g., blockchain, full decentralized system, public or private systems, partial or hybrid decentralized systems, etc.). A decentralized domain may be indicated by any name or identifier including any quantity of terms, words, tokens, or arrangements of any quantity of any types of elements (e.g., alphanumeric or other characters, symbols, numbers, etc.). The name or identifier preferably includes a name or identifier portion and an optional extension (e.g., “name.e1”, etc.). The name or identifier portion and extension may each include any quantity of terms, words, tokens, or arrangements of any quantity of any types of elements (e.g., alphanumeric or other characters, symbols, numbers, etc.).

Any quantity of any domain parameters, values, or other information may be associated with a domain. Domain and deactivation information may include any information arranged in any fashion (e.g., values for domain records, domain parameters, server names or addresses, domain names, deactivation listings, etc.). The domain and deactivation information may be stored on a blockchain and/or on an off-chain data source. The domain and deactivation information may be stored and retrieved based on any information (e.g., wallet or blockchain/network address, domain or user name, etc.).

The blockchain domains may be from any desired blockchains, and may be from the same and/or different blockchains. The domain information from the blockchain may be verified in any manner (e.g., encrypted signature, Merkle proof, etc.).

The domain takedown or deactivation of present invention embodiments may be triggered in response any quantity of any types of conditions (e.g., based on user messages, requests, and/or message signatures, time intervals, safety or reliability scores of domains and/or users, ratings, authority indications, content type, recency of access, demand for transfer, transactions, etc.).

The domain takedown or deactivation may include any manner of removing control (or transferring ownership) of a decentralized domain from a current user/owner and/or disabling (or preventing access to) any aspect of a decentralized domain (e.g., domain name, network resources, web site, service, content, control, etc.). For example, the decentralized domain may be transferred to any wallet account or address preventing access. The decentralized domain may be transferred to another user/owner, or to a storage location for awaiting transfer to another user/owner. The decentralized domain may be transferred to a storage location until release requirements are satisfied. The release requirements may include any desired conditions (e.g., a decision from appealing the deactivation to a reviewing authority (if one exists), a time period, correction of issues, etc.).

Further, any information (e.g., on-chain and/or off-chain records, metadata, etc.) associated with a decentralized domain may be modified to include an indication of deactivation. The indication may include any identifier (e.g., text, numeric values, symbols, etc.). Moreover, the deactivations may be tracked in any manner. For example, a listing of deactivated domains (or domains indicated for deactivation) may be maintained and include any desired information (e.g., domain information, wallet account or address information, user/owner information, etc.). The tracking or listing may be maintained by smart contracts associated with the decentralized domains, by different or standalone smart contracts, and/or by other modules. In addition, hosting information may be modified in any manner to indicate a deactivation (e.g., to redirect to a landing page or other web site, provide notification, etc.).

Once a deactivation is determined, access to the deactivated domain may be prevented in various manners (e.g., terminate processing of an access request and/or retrieval of domain content, disable operation of the domain, disable resolution functionality to locate the domain, etc.).

Having described preferred embodiments of a new and improved system, method, and computer program product for deactivation of decentralized domains, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of deactivating decentralized domains comprising:
monitoring, via at least one processor, for occurrence of a set of conditions associated with a decentralized domain of a decentralized system; and
deactivating, via the at least one processor, the decentralized domain in response to the occurrence of the set of conditions.

2. The method of claim 1, wherein the decentralized domain includes a blockchain domain, the decentralized system includes a blockchain, and the monitoring is performed via a smart contract associated with the decentralized domain.

3. The method of claim 1, wherein deactivating the decentralized domain includes:
transferring the decentralized domain to an address of the decentralized system preventing access to the decentralized domain.

4. The method of claim 1, wherein deactivating the decentralized domain includes:
transferring the decentralized domain to a different address until conditions are satisfied for transfer of the decentralized domain to a user.

5. The method of claim 2, wherein deactivating the decentralized domain includes:
tracking deactivations of decentralized domains via a second smart contract; and
preventing access to a corresponding decentralized domain in response to deactivation of the corresponding decentralized domain being tracked by the second smart contract.

6. The method of claim 1, wherein deactivating the decentralized domain includes:
modifying one or more records of the decentralized domain to indicate deactivation of the decentralized domain; and
preventing access to the decentralized domain based on the one or more modified records.

7. The method of claim 2, wherein the set of conditions includes one or more from a group of:
a number of signed messages from wallets requesting a takedown of the decentralized domain;
a time period in which the messages need to be signed by the wallets to indicate the takedown;
the wallets having accounts with a safety score satisfying a threshold indicating a reliable wallet account;
an age of the wallet accounts;
a signed message from a reviewing authority that performs a review of the decentralized domain; and
a safety score of the decentralized domain.

8. A system for deactivating decentralized domains comprising:
one or more memories; and
at least one processor coupled to the one or more memories, the at least one processor configured to:
monitor for occurrence of a set of conditions associated with a decentralized domain of a decentralized system; and
deactivate the decentralized domain in response to the occurrence of the set of conditions.

9. The system of claim 8, wherein the decentralized domain includes a blockchain domain, the decentralized system includes a blockchain, and the monitoring is performed via a smart contract of the at least one processor associated with the decentralized domain.

10. The system of claim 8, wherein deactivating the decentralized domain includes:
transferring the decentralized domain to an address of the decentralized system preventing access to the decentralized domain.

11. The system of claim 8, wherein deactivating the decentralized domain includes:
transferring the decentralized domain to a different address until conditions are satisfied for transfer of the decentralized domain to a user.

12. The system of claim 9, wherein deactivating the decentralized domain includes:
tracking deactivations of decentralized domains via a second smart contract; and
preventing access to a corresponding decentralized domain in response to deactivation of the corresponding decentralized domain being tracked by the second smart contract.

13. The system of claim 8, wherein deactivating the decentralized domain includes:
modifying one or more records of the decentralized domain to indicate deactivation of the decentralized domain; and
preventing access to the decentralized domain based on the one or more modified records.

14. The system of claim 9, wherein the set of conditions includes one or more from a group of:
a number of signed messages from wallets requesting a takedown of the decentralized domain;
a time period in which the messages need to be signed by the wallets to indicate the takedown;
the wallets having accounts with a safety score satisfying a threshold indicating a reliable wallet account;
an age of the wallet accounts;
a signed message from a reviewing authority that performs a review of the decentralized domain; and
a safety score of the decentralized domain.

15. A computer program product for deactivating decentralized domains, the computer program product comprising one or more computer readable media having instructions stored thereon, the instructions executable by at least one processor to cause the at least one processor to:
monitor for occurrence of a set of conditions associated with a decentralized domain of a decentralized system; and
deactivate the decentralized domain in response to the occurrence of the set of conditions.

16. The computer program product of claim 15, wherein the decentralized domain includes a blockchain domain, the decentralized system includes a blockchain, and the instructions include a smart contract associated with the decentralized domain to monitor for the occurrence of the set of conditions.

17. The computer program product of claim 15, wherein deactivating the decentralized domain includes:
transferring the decentralized domain to an address of the decentralized system preventing access to the decentralized domain.

18. The computer program product of claim 15, wherein deactivating the decentralized domain includes:
transferring the decentralized domain to a different address until conditions are satisfied for transfer of the decentralized domain to a user.

19. The computer program product of claim 16, wherein the instructions include a second smart contract, and deactivating the decentralized domain includes:
tracking deactivations of decentralized domains via the second smart contract; and
preventing access to a corresponding decentralized domain in response to deactivation of the corresponding decentralized domain being tracked by the second smart contract.

20. The computer program product of claim 15, wherein deactivating the decentralized domain includes:
modifying one or more records of the decentralized domain to indicate deactivation of the decentralized domain; and
preventing access to the decentralized domain based on the one or more modified records.

21. The computer program product of claim 16, wherein the set of conditions includes one or more from a group of:
a number of signed messages from wallets requesting a takedown of the decentralized domain;
a time period in which the messages need to be signed by the wallets to indicate the takedown;
the wallets having accounts with a safety score satisfying a threshold indicating a reliable wallet account;
an age of the wallet accounts;
a signed message from a reviewing authority that performs a review of the decentralized domain; and
a safety score of the decentralized domain.
